(19) United States
(12) Patent Application Publication
(10) Pub. No.: US 2002/0048348 A1
(43) Pub. Date: Apr. 25, 2002

(54) System for diagnosing failures of asymmetric digital subscriber line and method therefor

(76) Inventors: Byung-Wook Jin, Daejeon (KR); Hyun-Min Lim, Daejeon (KR); Bok-Kyu Hwang, Daejeon (KR); Geon-Bok Lee, Daejeon (KR); Hyung-Soo Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/951,073

(22) Filed: Sep. 10, 2001

(30) Foreign Application Priority Data
Oct. 24, 2000 (KR) 2000-62642

(51) Int. Cl. H04M 1/24; H04M 3/08

(52) U.S. Cl. 379/29.01; 379/1.04; 379/9; 379/14.01; 379/22; 379/27.01

(57) ABSTRACT

A system for diagnosing failures of ADSL comprises an access module for locating and monitoring the subscriber lines providing the ADSL services, a plurality of ADSL test devices each having various extension test boards corresponding to the test kinds detected for the failures of the subscriber lines accessed by the access module, and a control device for controlling the ADSL test devices. Preferably, extension boards may be additionally provided to adapt for increase of the number of the subscribers.

### FIELD OF THE INVENTION

The present invention relates to a system for diagnosing failures of an asymmetric digital subscriber line (ADSL) providing telephone and Internet services by testing the transmission equipment and lines, and a method therefor, and a recording medium programmed by a computer to perform the method.

### PRIOR ART OF THE INVENTION

Recently, the ADSL services have been extensively distributed because of being capable of exchanging data through the conventional telephone lines connected with Internet at low cost, but providing no practically effective integrated system for diagnosing failures of an ADSL except for using the conventional telephone line test system or a portable ADSL tester. Although such conventional test systems successfully dealt with the failures in small scale, there has been required a more effective integrated system for diagnosing ADSL failures as the number of ADSL subscribers greatly increases.

### SUMMARY OF THE INVENTION

Therefore, it is an object of the present invention to provide a system for diagnosing failures of ADSL providing telephone and Internet services by testing the transmission equipment and lines.

According to an aspect of the present invention, a system for diagnosing failures of ADSL comprises an access module for locating and monitoring the subscriber lines providing the ADSL services, a plurality of ADSL test devices each having various extension test boards corresponding to the test kinds detected for the failures of the subscriber lines accessed by the access module, and a control device for controlling the ADSL test devices. Preferably, extension boards may be additionally provided to adapt for increase of the number of the subscribers.

According to another aspect of the invention, a method for diagnosing failures of ADSL comprises the steps of registering a failure submission of a subscriber line on a subscriber's request, determining the failure kind of the failure submission to provide an additional extension board adapted for the failure kind and request the testing of the failure submission, and testing the subscriber line according to the failure kind to display the test result on a test screen. Preferably, the method further includes the step of performing the failure test through a corresponding device selected by analyzing the drivers of the present operable devices to display the test result and measuring device on a test screen if the failure test is not for the subscriber line.

According to still another aspect of the invention, there is provided a recording medium programmed by a computer to perform a method for diagnosing failures of ADSL, which comprises the steps of registering a failure submission of a subscriber line on a subscriber's request, determining the failure kind of the failure submission to provide an additional extension board adapted for the failure kind and request the testing of the failure submission, and testing the subscriber line according to the failure kind to display the test result on a test screen. Preferably, the recording medium is further programmed to include the step of performing the failure test through a corresponding device selected by analyzing the drivers of the present operable devices to display the test result and measuring device on a test screen if the failure test is not for the subscriber line.

Thus, the invention provides a system for diagnosing failures of ADSL by integratedly displaying all the stages of testing subscriber lines on the screen. The test stages are classified into pre-qualification test for determining whether ADSL services may be accepted, installation test for confirming the performance contracted for providing ADSL services, maintenance test for determining failed elements, and other miscellaneous test for measuring the voltages of the direct and alternate currents, loop resistance, and capacitance of the line.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram for illustrating the structure of the inventive system for diagnosing failures of ADSL;

FIG. 2 is a flow chart for illustrating the procedure of diagnosing failures of ADSL according to the present invention;

FIG. 3 shows a failure submission registration window displayed on a monitor screen in the inventive system for diagnosing failures of ADSL;

FIG. 4 shows a maintenance test window displayed on a monitor screen in the inventive system for diagnosing failures of ADSL;

FIG. 5 shows a pre-qualification/installation test window displayed on a monitor screen in the inventive system for diagnosing failures of ADSL; and

FIG. 6 shows other miscellaneous test window displayed on a monitor screen in the inventive system for diagnosing failures of ADSL.

### PREFERRED EMBODIMENTS OF THE INVENTION

Hereinafter, preferred embodiments of the present invention will be described in detail with reference to the accompanying drawings.

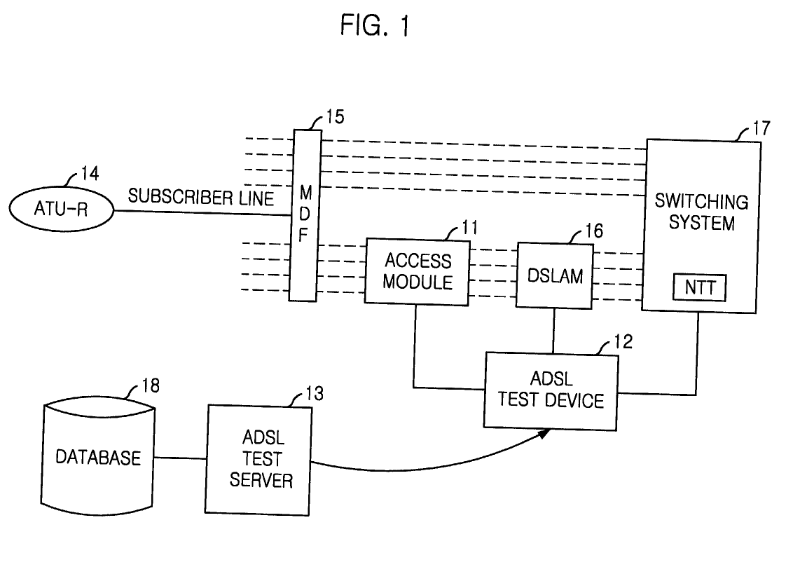

Referring to FIG. 1, the system for diagnosing failures of ADSL is designed to contain additional extension board to adapt for increase of the number of subscribers. An access module 11 accesses the subscriber lines. A plurality of ADSL test devices 12 may include various test boards to perform various tests corresponding to test kinds such as ADSL, POTS, E1/T1, etc. The ADSL test devices 12 are controlled by ADSL test server 13.

Describing the procedure of diagnosing failures of ADSL by the system, the access module 11 accesses the subscriber line submitted for failure test, which is tested by the ADSL test device 12 to ascertain its failure. Then, in order to accomplish the test, the test is divided into multiple stages for respectively perform the pre-qualification test, installation test, maintenance test, and other miscellaneous test, which are integratedly displayed on a monitor screen, so that the operator may routinely perform the test without skill in detailed test items.

The pre-qualification test is to test qualification of a subscriber for receiving ADSL services. The subscriber line is connected through MDF (Main Distribution Frame) 15 of a telephone office to the switching system 17. The ADSL test device 12 tests the subscriber line through the test trunk NTT (Numbered Test Trunk) of the switching system 17. The test result is stored in the database 18, informed through the marketing department to the subscriber.

The installation test is to confirm the communication quality contracted with the subscriber after installing ATU-R (ADSL Termination Unit-Remote) 14 in the subscriber's home by testing with DSLM (DSL Access Multiplexer) 16.

The maintenance test is to locate the failure submitted by the subscriber. The other miscellaneous test is to test the direct voltage, alternate voltage, loop resistance, and capacitance of the line, and other supplementary functions that are not directly connected to ADSL services but may affect them.

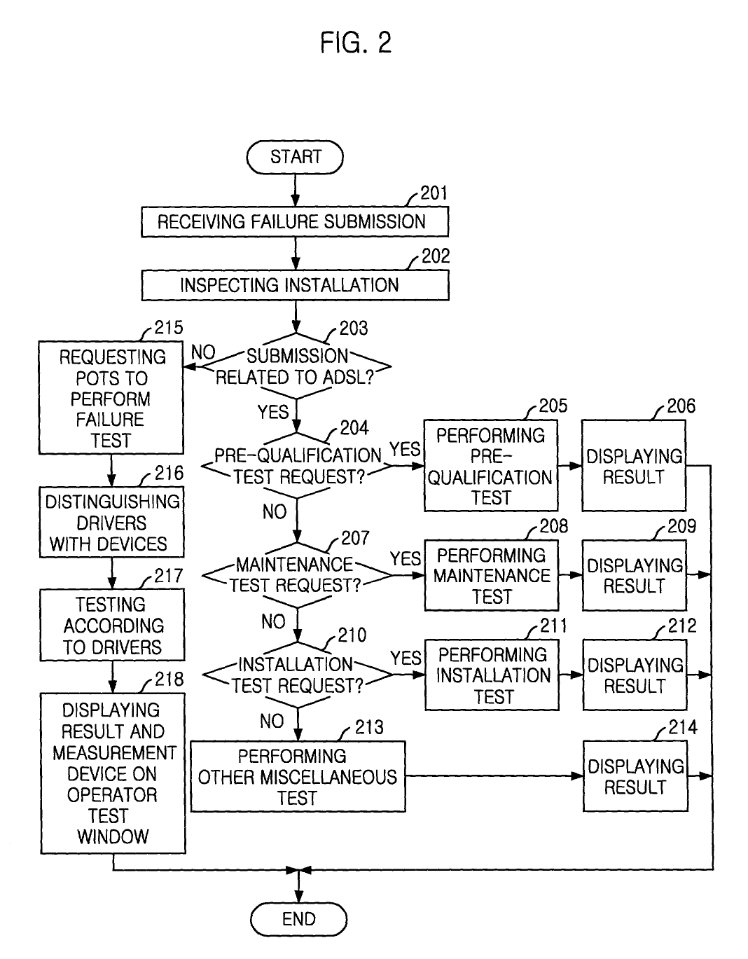

More specifically describing the steps of diagnosing failures of ADSL in connection with FIG. 2, the system receives a failure submission from a subscriber in step 201. Then, the subscriber's installation is inspected in step 202 to confirm the failure submission related to ADSL in step 203. If related to ADSL, the submission is confirmed related to pre-qualification test request in step 204. If so, the pre-qualification test is performed in step 205, displaying the result on the pre-qualification test window in step 206.

However, if not so, it is confirmed related to maintenance test request in step 207. If so, the maintenance test is performed in step 208, displaying the result on the maintenance test window in step 209.

Not being the maintenance test request, it is confirmed related to installation test request in step 210. If so, the installation test is performed in step 211, displaying the result on the installation test window in step 212. If not so, the other miscellaneous test is performed in step 213, displaying the result on the miscellaneous test window in step 214.

Meanwhile, if the failure submission is not related to ADSL, the system requests POTS (Plain Old Telephone Service) test device to perform the failure test in step 215. Then, POTS test device performs the failure test in step 217 according to the drivers distinguished with the presently operable devices in step 216, displaying the result and measurement device on the operator test window in step 218.

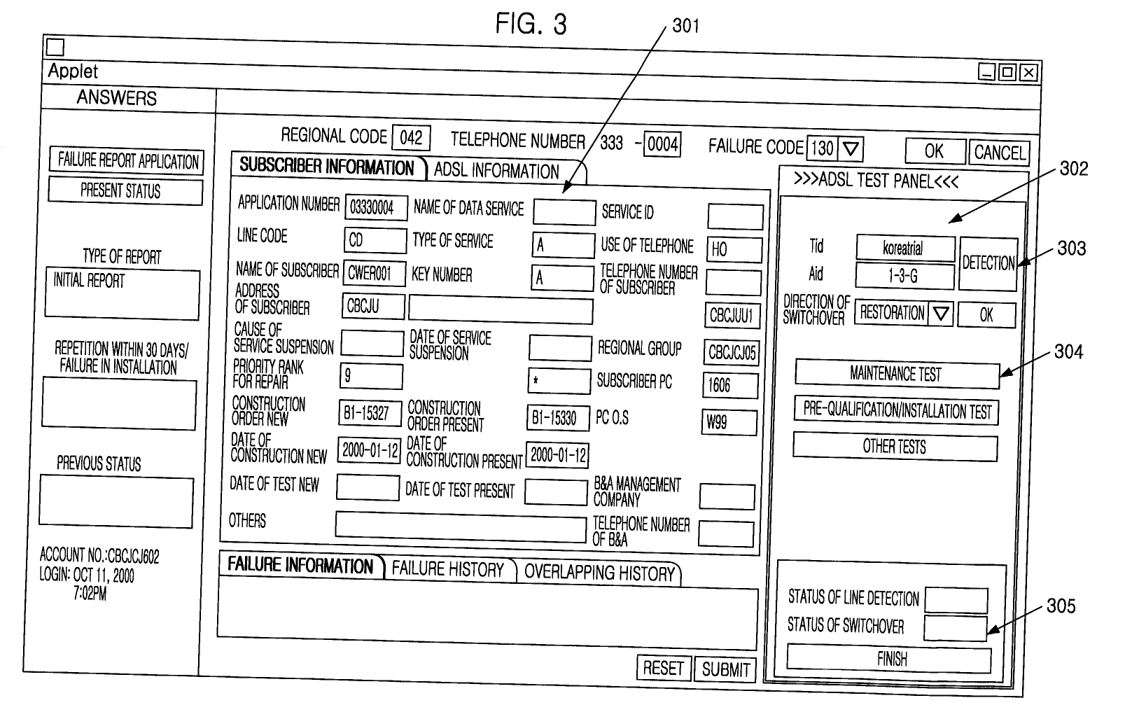

Referring to FIG. 3, receiving a failure submission from a subscriber, the system for diagnosing failures of ADSL displays the information of the subscriber on the submission registration window together with a supplementary window 302 for ADSL test. In addition, there are displayed on the window the access function 303 for accessing the ADSL port, and pre-qualification test button 304 according to the failures.

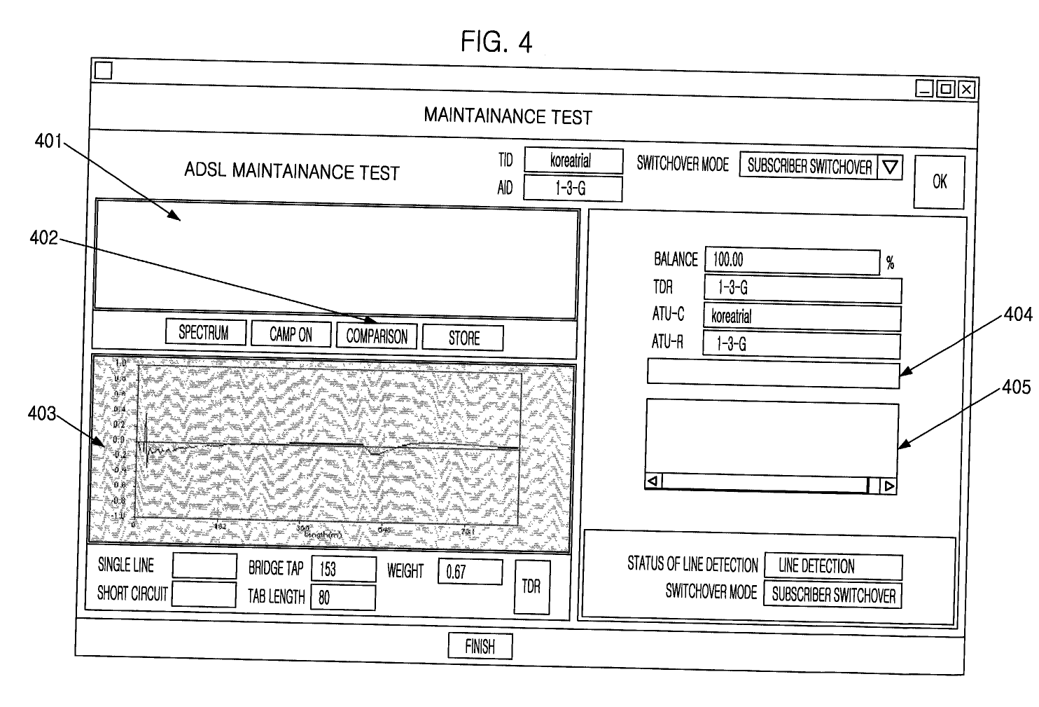

Referring to FIG. 4, the maintenance test window displays comparing button 402 for comparing the previous test data in the spectrum analysis window when the line state is extremely unstable, and spin test button 404 for performing batch test on selection of a desired test function. In addition, a message window 405 is created to display a message concerning the test result of the ADSL test device, enabling specialized analysis.

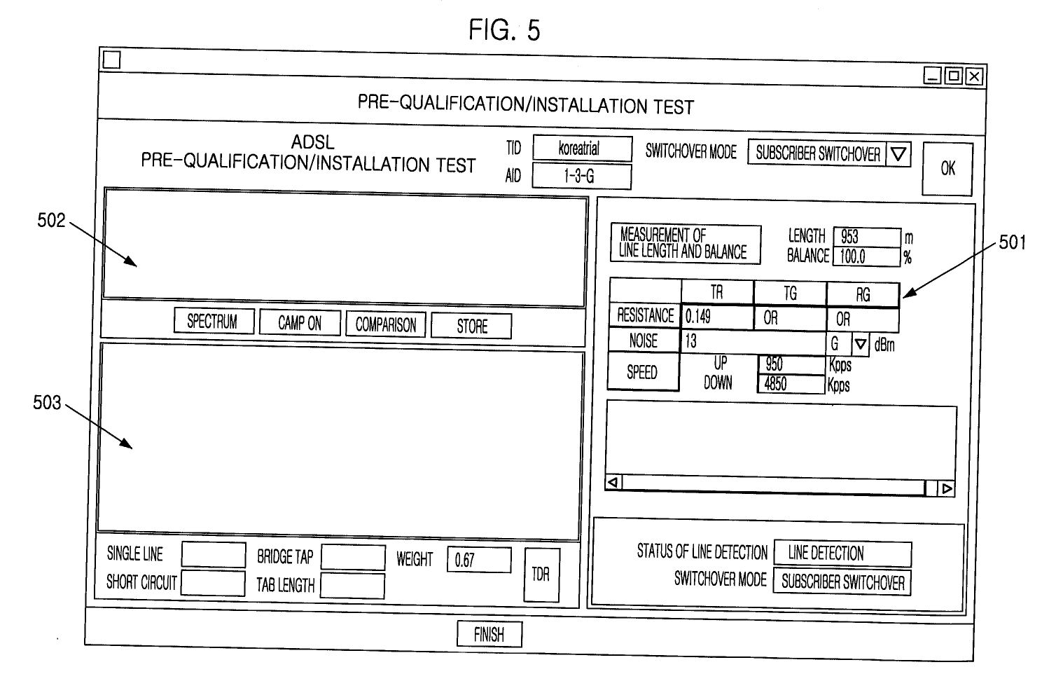

Referring to FIG. 5, the pre-qualification/installation test window consists of spectrum analysis window 502 and TDR analysis window 503 as in the maintenance test window. In addition, there is displayed the function 501 for measuring line length, balance, loop resistance, noise, and virtual transmission speed.

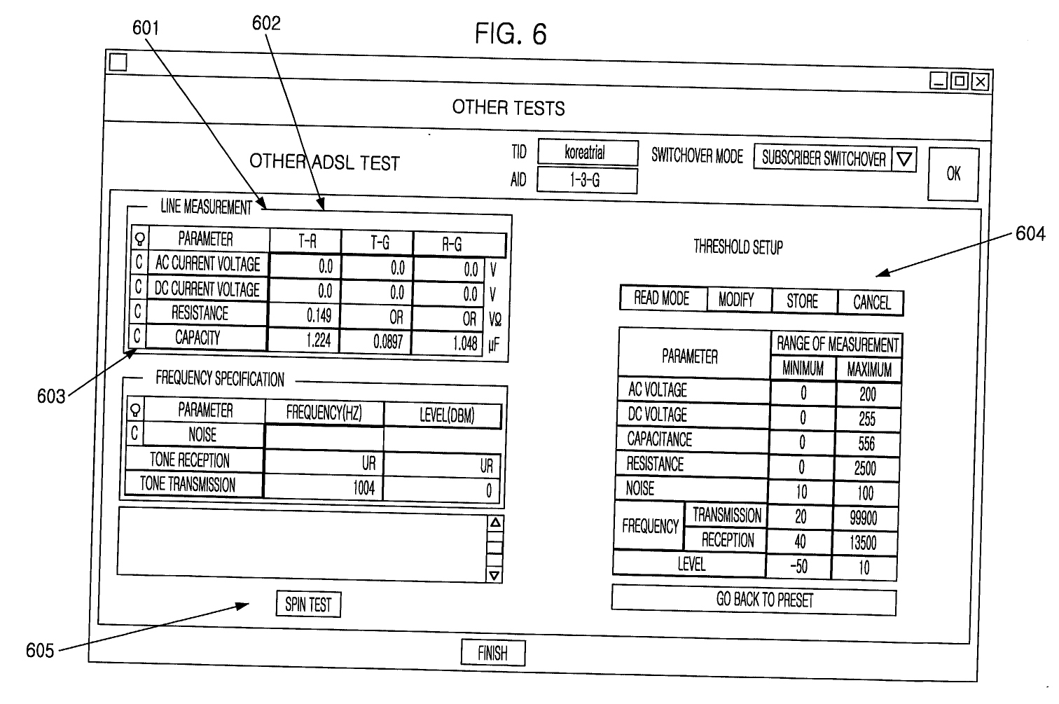

Referring to FIG. 6, the other miscellaneous test window includes the test window 601 for measuring the direct voltage, alternate voltage, loop resistance, capacitance, etc. of the line. Also provided is a button for selecting one of the paths T-R (Tip-Ring), T-G (Tip-Ground), R-G (Ring-Ground), and R-T to enable various tests. A continuous test button 603 for each test item is also provided to detect the line state in real time. A spin test function 605 enables each of all test items to be tested. A reference value set window 604 is provided to set the reference value of each measurement, assisting in judgment of the test result.

Thus, the invention enables the ADSL test devices to be commonly connected by installing the access module separately from them so as to accommodate a large number of subscribers and reduce the investment cost. In addition, the operating software for the test devices installed in separate places is installed in a single server controlling them, thus facilitating maintenance of software as well as reducing the cost. The separate test window for each test stage enables the operator to readily perform the test without delicate skill. The test items classified according to the test stages facilitate their perfect management. Besides, the system may be applied independently from or in parallel with the existing test system for the telephone subscriber line, increasing its availability.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. A system for diagnosing failures of asymmetric digital subscriber line (ADSL), comprising:
an access module for locating and monitoring the subscriber lines providing the ADSL services;
a plurality of ADSL test devices each having various extension test boards corresponding to the test kinds detected for the failures of the subscriber lines accessed by said access module; and
a control device for controlling said ADSL test devices, wherein extension boards are additionally provided to adapt for increase of the number of the subscribers.

2. A method for diagnosing failures of ADSL, comprising the steps of:
registering a failure submission of a subscriber line on a subscriber's request;
determining the failure kind of said failure submission to provide an additional extension board adapted for said failure kind and request the testing of said failure submission; and
testing said subscriber line according to said failure kind to display the test result on a test screen.

3. The method for diagnosing failures of ADSL as recited in claim 2, further including the step of performing the failure test through a corresponding device selected by analyzing the drivers of the present operable devices to display the test result and measuring device on a test screen if the failure test is not for the subscriber line.

4. The method for diagnosing failures of ADSL as recited in claim 2, wherein the step of registering a failure submission is to display on the registering window the information of the subscriber, a supplementary window for testing, function of accessing the port of the subscriber line, test button for testing the preliminary installation, and state of accessing the subscriber line.

5. The method for diagnosing failures of ADSL as recited in claim 2, wherein the step of testing said subscriber line further includes the steps of:
performing pre-qualification test with the result displayed on the pre-qualification test window if the test is pre-qualification test;
performing maintenance test with the result displayed on the maintenance test window if the test is maintenance test; and
performing installation test with the result displayed on the installation test window if the test is maintenance test.

6. The method for diagnosing failures of ADSL as recited in claim 5, wherein the step of testing said subscriber line further includes the step of performing other miscellaneous test with the result displayed on the other miscellaneous test window if the test is other miscellaneous test.

7. The method for diagnosing failures of ADSL as recited in claim 5, wherein the procedures of performing both said pre-qualification and installation tests generate the spectrum analysis window and TDR (Time Domain Reflector) analysis window on the screen to display the length of the line required for the pre-qualification test, balance measurement function, loop resistance, noise, and virtual transmission speed estimate function.

8. The method for diagnosing failures of ADSL as recited in claim 5, wherein the procedure of performing said maintenance test generates the spectrum analysis window and TDR analysis window on the screen to display comparing button for comparing the previous test data when the line is unstable, spin test button for performing batch test on selecting a desired test function, and message window for displaying a message of the test result on said spectrum analysis window.

9. A computer readable recording medium storing instructions to perform a method for diagnosing failures of ADSL, which comprises the steps of:
registering a failure submission of a subscriber line on a subscriber's request;
determining the failure kind of said failure submission to provide an additional extension board adapted for said failure kind and request the testing of said failure submission; and
testing said subscriber line according to said failure kind to display the test result on a test screen.

10. The computer readable recording medium as recited in claim 9, further programmed to include the step of performing the failure test through a corresponding device selected by analyzing the drivers of the present operable devices to display the test result and measuring device on a test screen if the failure test is not for the subscriber line.
